(19) United States
(12) Patent Application Publication
(10) Pub. No.: US 2019/0129727 A1
(43) Pub. Date: May 2, 2019

(54) USER PATTERN PREDICTION USING A NEURAL NETWORK

(71) Applicant: salesforce.com, inc., San Francisco, CA (US)

(72) Inventor: Jean Elie Bovet, Los Angeles, CA (US)

(21) Appl. No.: 15/795,805

(22) Filed: Oct. 27, 2017

(51) Int. Cl. G06F 9/44; G06F 9/445; H04L 29/08

(52) U.S. Cl. CPC G06F 9/4443; G06N 3/04; H04L 67/306; G06F 9/4451

(57) ABSTRACT

A system may implement a user-specific application interface (e.g., a user interface) to improve user retention of using the application and user efficiency when running the application. The system may implement the user interface based on a prior use of the interface, or based on one or more identifying characteristics of the user device. For example, a user device may determine one or more identifying characteristics that may include a device type of the user device (e.g., a tablet), a timestamp, or location information of the user device. The user device may, in turn, attempt to access a user-specific profile. Because the profile may be user-specific, the user device may receive an indication of the profile based on the user's prior use of the interface, the type of device, or a combination thereof. The user device may, in turn, display the user-specific interface at the user device.

### FIELD OF TECHNOLOGY

The present disclosure relates generally to database systems and data processing, and more specifically to user pattern prediction using a neural network.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cases, a user may access an application on the cloud platform from one or more mobile devices. The user interface of the application may be statically configured for each user and for each of the user's devices. That is, the application may not be tailored to a specific user or the mobile device from which the user is accessing the application. For example, the application may operate and look the same regardless of the user of the application or the device type by which the application is accessed. In such cases, these applications may not be optimized for individual users, and user retention on the application may be reduced due to decreased efficiency when running the application.

### BRIEF DESCRIPTION OF THE DRAWINGS

FIGS. 1 through 5 illustrate examples of systems for arranging a user interface of an application that supports user pattern prediction using a neural network in accordance with aspects of the present disclosure.

FIGS. 6 and 7 show block diagrams of a device that supports user pattern prediction using a neural network in accordance with aspects of the present disclosure.

FIG. 8 illustrates a block diagram of a system including a user device that supports user pattern prediction using a neural network in accordance with aspects of the present disclosure.

FIGS. 9 and 10 show block diagrams of a device that supports user pattern prediction using a neural network in accordance with aspects of the present disclosure.

FIG. 11 illustrates a block diagram of a system including a server that supports user pattern prediction using a neural network in accordance with aspects of the present disclosure.

FIGS. 12 and 13 illustrate methods for user pattern prediction using a neural network in accordance with aspects of the present disclosure.

### DETAILED DESCRIPTION

Applications may be generally configured for a tailored user experience. However, many of these applications are designed based on preferences of a broad spectrum of users. For example, certain applications may adapt based on the preferences of groups of users—not based on the preference or use patterns of one individual user of the application. Thus, such applications are not truly user-specific. By utilizing identification information specific to an individual user's device, location, or time of day, an application may be tailored for a more user-centric and personalized experience.

In a first example, a user interface of an application may be arranged at a user device. Identification information—such as the type of device or location information of the device—may be determined at the user device. Upon determining the user identification information, a request may transmitted to a server to access a user-specific profile. The request may, for example, include the determined identification information of the user device. In return, the user device may receive an indication of the user profile sought by the request. The indication of the user profile may include an arrangement of elements—such as a list, an icon, or a card view—that may be based on a prior use of the user interface for that particular combination of device type, time, or location. For example, the arrangement of elements may correspond to the way a user previously interacted with the user interface on a specific device, at a particular location, and at that particular time of day. The user interface may subsequently be displayed at the user device based in part on the indication of the user profile.

In another example, first identification information of a user device may be received at a server. The identification information—such as the type of device—may be determined based on the reception of the identification information. Upon determining the device type, for example, the server may receive a request to access a user profile. The request may include the identification information of the user device. In return, the server may generate an indication of the user profile sought by the request. The indication of the user profile may include an arrangement of elements—such as a list, an icon, or a card view—that may be based on a prior use of the user interface corresponding to the determined identification information. The server may subsequently transmit the indication of the user profile to the user device.

In another example, a mobile device may determine usage patterns of the application using a local neural network, and store these usage patterns locally. For example, the mobile device may determine how the user interface of the application is used at certain times of day and at certain locations. In such examples, when the mobile device requests access to the application from the server, identification information for the device or the user may not be transmitted from the server to the mobile device. Instead, the server may transmit the data to the mobile device necessary to access the application, and the mobile device may arrange the user interface based on the locally-stored usage patterns.

The system described above may support various user devices, multiple servers, and may allow for access to numerous user profiles. For example, different user devices may each transmit a request to access a same or a different user profile, and each indication of the user profile may be based on the user profile, the specific device type, or both. The system may also include mechanisms to re-generate an indication of a user profile based on changes in the user device's identifying information. In some cases, the system may support aggregation of device identification information from a plurality of user devices, and each user profile may be based in part on the aggregated information.

Aspects of the disclosure are initially described in the context of an environment supporting an on-demand database service. Further aspects of the disclosure are described with respect to systems for arranging a user interface of an application, such as at a user device or at a server. Aspects of the disclosure are further illustrated by and described with reference to apparatus diagrams, system diagrams, and flowcharts that relate to user pattern prediction using a neural network.

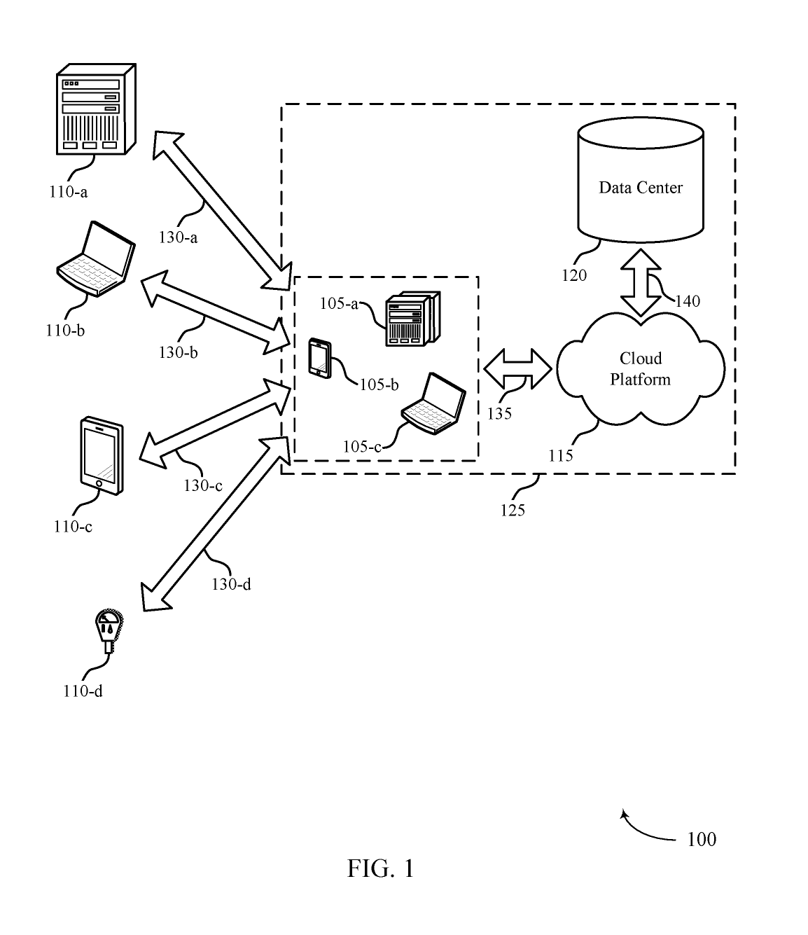

FIG. 1 illustrates an example of a system 100 for cloud computing that supports user pattern prediction using a neural network in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The cloud clients 105 of subsystem 125 may be examples of one or more user devices and data center 120 may be an example of or include, as a component, a server to which a cloud client 105 may attempt to request access to a user profile from. For example, cloud client 105 may determine first identification information. The identification information may, for example, include a device type of cloud client 105, a timestamp, or location information of cloud client 105. In other examples, the identification information may include a timestamp, a location of cloud client 105, or both. Upon determining the first identification information, cloud client 105 may utilize network connection 135 to transmit a request to access a user profile at the cloud client 105. In some examples, the request may include the determined identification information.

The cloud client 105 may, in return, receive an indication of the user profile based on transmitting the request. The indication of the user profile may include an arrangement of elements—such as list, application icon, or a card view—that may be based on a prior use of the user interface. For example, the indication of the user profile may be specific to the user of cloud client 105 or may be specific to the device type of cloud client 105. In other examples, the indication of the user profile may be specific to the cloud client 105 based on a timestamp or location information of the cloud client 105. Upon receiving the indication of the user profile, the cloud client 105 may display the user interface. In some examples, the cloud client 105 may display the user interface based at least in part on receiving the indication of the user profile.

In another example, data center 120 may receive first identification information of the cloud client 105. The data center 120 may, for example, determine a device type of the cloud client 105 based on receiving the first identification information. In some examples, the device type may be a phone, a tablet, or another type of user device. Upon determining the device type, the data center 120 may receive a request from the cloud client 105 to access a user profile. In some examples, the user profile may contain the first identification information (e.g., the device type of cloud client 105).

In some examples, the data center 120 may generate an indication of the user profile based on receiving the request to access the user profile. The data center 120 may, in return, generate an indication of the user profile based on receiving the request. As described above, the indication of the user profile may include an arrangement of elements—such as list, an application icon, or a card view—that may be based on a prior use of the user interface. In other examples, the arrangement of elements may correspond to the first identification information of cloud client 105. Upon generating the indication of the user profile, data center 120 may transmit, to the cloud client 105, the indication of the user profile. In either example, the system may support various cloud clients 105, multiple data centers 120, and may allow for access to multiple user profiles.

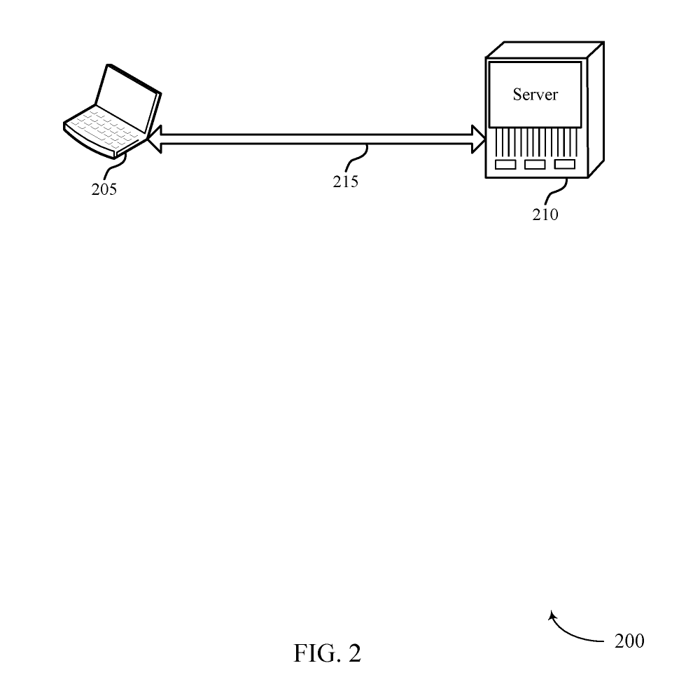

FIG. 2 illustrates an example of a system 200 that supports user pattern prediction using a neural network in accordance with various aspects of the present disclosure. The system 200 may include a user device 205, which may be an example of a cloud client 105 as described with reference to FIG. 1; and a server 210, which may be an example of the data center 120 as described with reference to FIG. 1. In some cases, the server 210 may be an example of components of a data center 120, a cloud platform 115, or some combination of these, as described with reference to FIG. 1. Additionally or alternatively, for example, the system 200 may include one or more connections, such as connection 215.

In some examples, the user device 205 may display a user interface of an application by way of the server 210. For example, the user device 205 may determine first identification information of the user device 205. In some examples, the first identification information may include a device type—such as a phone or a tablet—of the user device 205. In other examples, the first identification information may additionally or alternatively include a timestamp, location information of the user device 205, or both.

Upon determining the first identification information of the user device 205, the user device 205 may transmit a request to access a user profile. In some examples, the transmission may be from the user device 205 to the server 210 via connection 215. The transmission may, for example, include the first identification information of the user device 205. The transmission may be received at the server 210. The user profile may be associated with an account or profile of one specific user. In some examples, the user profile may be associated with a social media account, a retail consumer account, a business account, or the like.

In return, the user device 205 may receive an indication of the user profile. In some examples, the user device 205 may receive an indication of the user profile based at least in part on the transmission of the request to access the user profile and the indication of the user profile may be received via connection 215. The user profile may, for example, include an arrangement of elements on the user interface, such as a list, an application icon, a card view, or a combination thereof. In some examples, the indication of the user profile may be based on a prior use of the user interface corresponding to the first identification information. For example, the indication of the user profile may be based on a single user's prior use of the application, a single user's prior use of the application on a specific device, or both. The prior usage patterns, that take into account the device type, the time of day, and/or the location, may be determined using a local neural network. These patterns of usage may be stored at the user device 205, may be transmitted or otherwise indicated to server 210, or both. In some examples, the user device 205 may then display the user interface at the user device 205, which may be based at least in part on the indication of the user profile.

In other examples, the user device 205 may receive a second indication of the user profile at the user device 205 based at least in part on a change in the device type (or some other factor, such as a change in the time or location). In some examples, the user device 205 may receive the second indication of the user profile via connection 215. For example, a user may receive an indication of the user profile at a first device (e.g., a phone), but later change the device by which he or she accesses the user profile. Thus, the second user device (e.g., a tablet) may receive a second indication of the user profile based at least in part on the change in device type. In some examples, the user interface may be displayed at the user device 205 based at least in part on the second indication of the user profile.

In another example, the user device 205 may determine second identification information. For example, the second identification information may include a timestamp, location information of the user device 205, or both. The second identification information may be used in conjunction with the first identification information. For example, the user device 205 may ultimately display the user interface based on a device type of the user device 205 and based on the timestamp, the location information of the user device 205, or some combination. In some examples, the second identification information may change. For example, a user may attempt to access a user profile at a different location, or at a different time. Thus the user device 205 may receive a third indication of the user profile based at least in part on a change in the second identification information. In some examples, the user device 205 may then display the user interface based at least in part on the third indication of the user profile.

Additionally or alternatively, for example, the server 210 may receive first identification information of the user device 205. In some examples, the server 210 may determine a device type of the user device 205. The server 210 may, for example, determine the device type of the user device 205 based at least in part on the first identification information received from the user device 205. In other examples, the first identification information may include a timestamp, or location information of the user device 205. The server 210 may subsequently, for example, receive a request to access a user profile from the user device 205. The request may include the first identification information which may, in some examples, include the device type of the user device 205.

In another example, the server 210 may generate an indication of the user profile based in part on receiving the request to access a user profile. In some examples, server 210 may generate an indication of the user profile that includes an arrangement of elements based in part on a prior use of the user interface. The arrangement of elements may also be based at least in part on a prior use of the user interface on a specific device type. In some examples, the server 210 may then transmit the indication of the user profile to the user device 205.

Additionally or alternatively, for example, the server 210 may generate a second indication of the user profile. In some examples, the second indication of the user profile may include a second arrangement of elements to be displayed on the user interface. The second identification information a change in the first identification information, or in response to the determination of additional identification information. Thus the indication of the user profile may adapt based on a change in device type, or based on the acquisition of additional identification information, such as a timestamp or location information of the user device 205. In some examples, the server 210 may transmit the second indication of the user profile to the user device 205.

In another example, the server 210 may receive a second request to access the user profile from the user device 205. The second request may, for example, comprise additional identification information, such as a timestamp or location information of the user device 205, as descried above. The second request may, for example, result in the server 210 generating a third indication of the user profile. This indication of the user profile may be different than the original indication and, in some examples, may be based on the acquisition of additional identification information, a change in the second identification information, or a combination thereof. Upon the generation of the third indication of the user profile, the server 210 may transmit the indication to the user device 205.

In yet another example, the server 210 may generate a notification based in part on receiving a request to access a user profile. The notification may be generated for security purposes. For example, the notification may be generated based on the server 210 receiving a request to access a user profile. The notification may be transmitted—to the user device 205—to indicate that a user is attempting to access his or her user profile. In some examples, this notification may be interactive such that the user of user device 205 may grant or deny access to his or her user profile, such as a two-step verification process. In other examples, the notification may serve to alert a user of the user device 205 of a change or an update made to his or her user profile.

Additionally or alternatively, for example, the server 210 may aggregate first identification information from a plurality of user devices. In some examples, the indication of the user profile may be based at least in part on the aggregation of the first identification information. Thus the aggregation may serve as a manner in which the server 210 may acquire necessary information to arrange a user interface. For example, the server 210 may monitor usage of the user interface across multiple user devices and aggregate this information. This may allow for the server to more-accurately discern different types of devices and the manner in which the user interface should be arranged on any one particular device.

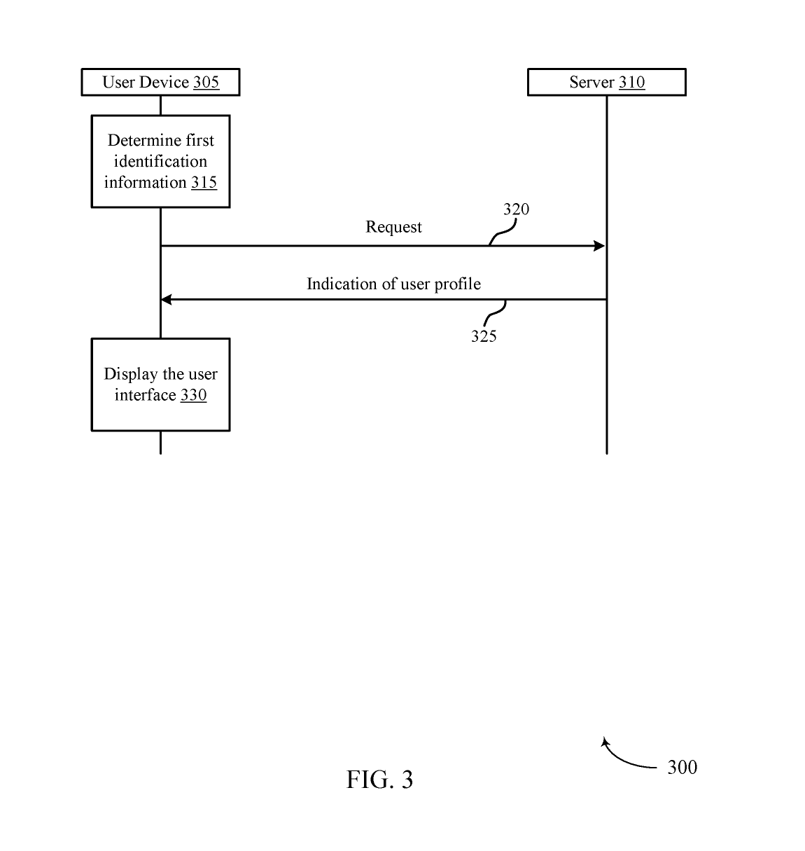

FIG. 3 illustrates an example of a system 300 that supports user pattern prediction using a neural network in accordance with various aspects of the present disclosure. The system 300 may include a user device 305, which may be an example of user device 205 as described with reference to FIG. 2; and a server 310, which may be an example of the server 210 as described with reference to FIG. 2.

System 300 may be an example of arranging a user interface of an application at a user device 305. In some examples, the user device 305 may arrange a user interface of an application by way of the server 310. For example, the user device 305 may determine first identification information 315. The determination of first identification information 315 may include determining a device type of the user device 305, a time of day, a location, or some combination of these factors. For example, the user device 305 may be a tablet, a phone, or another type of user device. Subsequently, the user device 305 may transmit a request 320 to the server 310. In some examples, the request 320 may include a request to access a user profile for the user device 305.

Upon transmitting the request 320 to the server 310, the user device 305 may receive an indication of the user profile. In some examples, the indication of the user profile may be received at the user device 305 in response to the request 320. The indication of the user profile may, for example, include an arrangement of elements—such as a list, an application icon, or a card view—that is based at least in part on a prior use of the user interface. In some examples, the indication of the user profile may be based at least in part on a prior use of the user interface corresponding to the first identification information (e.g., a phone). In some examples, the user device 330 may subsequently display the user interface based at least in part on the indication of the user profile 325.

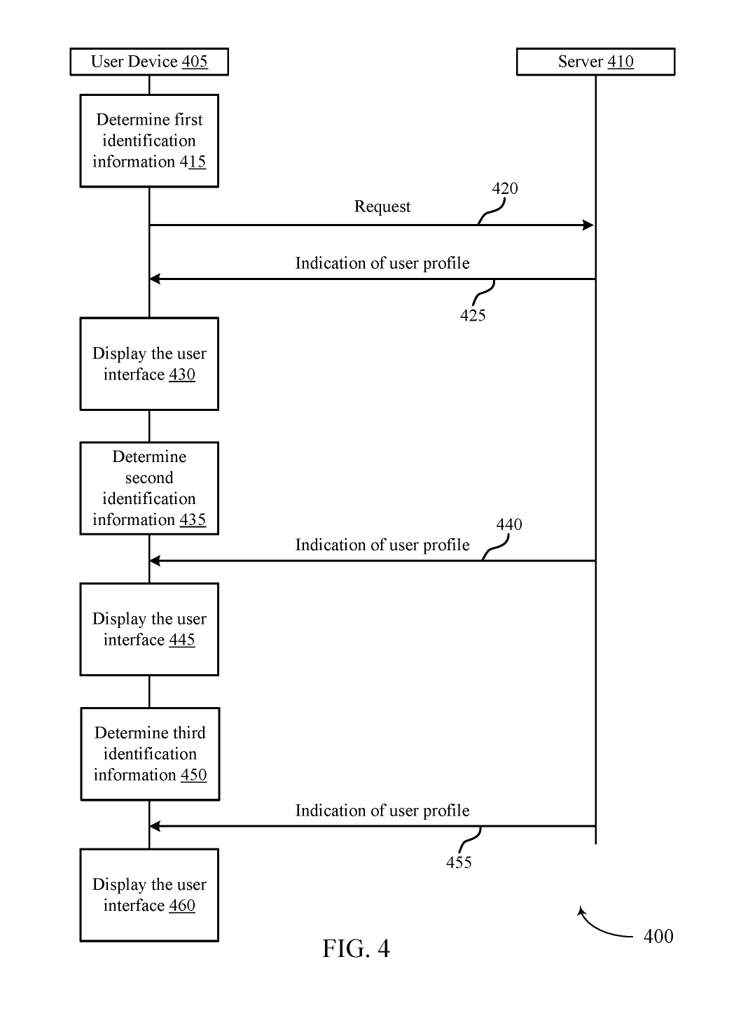

FIG. 4 illustrates an example of a system 400 that supports user pattern prediction using a neural network in accordance with various aspects of the present disclosure. The system 400 may include a user device 405, which may be an example of user device 205 or 305 as described with reference to FIGS. 2 and 3; and server 410, which may be an example of server 210 or 310 as described with reference to FIGS. 2 and 3.

System 400 may be an example of arranging a user interface of an application at a user device 405. In some examples, the user device 405 may arrange a user interface of an application by way of the server 410 and may determine first identification information 415. As discussed above, the determination may include determining a device type of the user device 405—such as a tablet, a phone, or a similar-type device. The user device 405 may transmit a request 420 to the server 410 in response to the determination of the device type. In some examples, the request 420 may include a request to access a user profile for the user device 405.

Upon transmitting the request 420 to the server 410, the user device 405 may receive an indication of the user profile, which may be received at the user device 405 in response to the request 420. The indication of the user profile may, for example, include an arrangement of elements—such as a list, an application icon, or a card view—that is based at least in part on a prior use of the user interface. In other examples, the arrangement of elements may be device-specific. Meaning that the arrangement of elements may be different on one device (e.g., a phone) compared to a second device (e.g., a tablet). In some examples, the indication of the user profile may be based at least in part on a prior use of the user interface corresponding to the first identification information (e.g., a phone). In some examples, the user device 405 may subsequently display 430 the user interface based at least in part on the indication of the user profile 425.

In some examples, the user device 405 may determine second identification information 435. The second identification information 435 may include, for example, a timestamp, a location information of the user device, or both. In other examples, the identification information may correspond to device-specific information, such as device-specific hardware, or software (e.g., an application installed on the user device 405). The second identification information of the user device 405 may indicate a change in one or more attributes of the user device 405 used to arrange a user interface of an application. Meaning that a change in second identification information may indicate to the server 410 to change one or more features of the indication of the user profile. Upon determining second identification information 435 of the user device 405, the user device 405 may receive an indication of the user profile 440. In some examples, prior to receiving an indication of the user profile 440, the user device 405 may transmit a second request to the server 410—similar to request 420. The request may, in some examples, include the determined second identification information 435. As described above, the indication of the user profile 440 may be based in part on the second identification information, or a change in the second identification information. Thus a change in time, location, or another attribute of the user device 405 may result in the user device 405 receiving a different indication of the user profile 440. Upon receiving the indication of the user profile 440, the user device 405 may display the user interface 445.

In another example, the user device 405 may determine third identification information 450. In some examples, the third identification may include a timestamp, a location information of the user device, or both. In other examples, the identification information may correspond to device-specific information, such as device-specific hardware, or software. Thus the third identification information may be a same type of identification information that could be included in the second identification information, discussed above. Meaning that the second identification information may include a timestamp, and the third identification information may include location information of the user device 405. In other examples, the determination of the third identification information 450 may be based in part on a change in the second identification information. Thus if a user of the user device 405 were to change location, or attempt to access a user profile at a different time, the change in identification information may be detected. This change may result in the user interface being arranged in a different manner. Thus, after the determination of the third identification information 450, the user device 405 may receive an indication of the user profile 455. In some examples, prior to receiving an indication of the user profile 455, the user device 405 may transmit a third request to the server 410—similar to request 420. The request may, in some examples, include the determined third identification information 450. The indication of the user profile 455 may contain an arrangement of elements on the user interface that are correlated to the third identification information. The user device may then display the user interface 460, which may be a different user interface than display 430 and display 445.

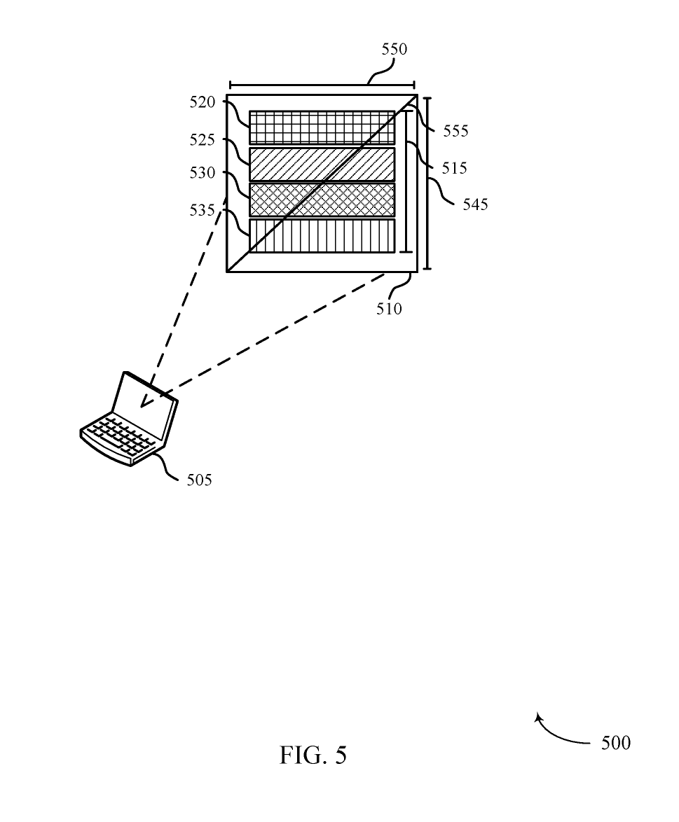

FIG. 5 illustrates an example of a system 500 that supports user pattern prediction using a neural network in accordance with various aspects of the present disclosure. The system 500 may include user device 505, which may be an example of user device 205, 305, or 405 as described with reference to FIGS. 2 through 4; display 510, which may include first dimension 545, second dimension 550, and third dimension 555; and user interface 515, which may include interface elements 520, 525, 530, and 535. In some examples, interface elements 520, 525, 530, and 535 may collectively or individually be referred to as a list. In other examples, each of the first dimension 545, the second dimension 550, and the third dimension 555 may be referred to as a first length 545, a second length 550, and a third length 555, respectively.

System 500 may illustrate an example of a user interface 515 arranged on a user device 505. In some examples, the user device 505 may determine first identification information that includes at least one of a device type of the user device 505, a timestamp, or location information of the user device 505. The user device 505 may transmit a request to a server (e.g., a server 210 as described with reference to FIG. 2) to access a user profile. In some examples, the request may include the first identification information. In return, the user device 505 may receive an indication of the user profile based on transmitting the request. The user device 505 may subsequently display the user interface 515 at the display 510 and, in some examples, the user interface 515 may be displayed based at least in part on the indication of the user profile.

In some examples, the user interface 515 may include an arrangement of interface elements 520, 525, 530, and 535. Each of the interface elements 520, 525, 530, and 535 may correspond to a different aspect or feature of the user profile and may be displayed, in part, based on the first identification information. In other examples, the order of each of the interface elements 520, 525, 530, and 535 may be based on the first identification information. Thus the order of interface elements 520, 525, 530, and 535 may differ if the user device 505 were, for example, a phone versus a tablet. Additionally or alternatively, for example, the order of the interface elements 520, 525, 530, and 535 might also change based on the user device 505 receiving second identification information. As discussed above, for example, the second identification information may include a timestamp, location information of the user device 505, or both. So the order of interface elements 520, 525, 530, and 535 may differ based on the first identification information, the second identification information, or both.

In some examples, interface elements 520, 525, 530, and 535 may be displayed in the form of a list. Meaning that interface elements 520, 525, 530, and 535 may be displayed in a consecutive order. In some examples, the list of interface elements 520, 525, 530, and 535 may be displayed one below the other (e.g., interface element 525 below interface element 520). In other examples, interface elements 520, 525, 530, and 535 may be displayed as application icons. Meaning that interface elements 520, 525, 530, and 535 may be displayed as images (e.g., a logo). In some examples, the images of interface elements 520, 525, 530, and 535 may be displayed in a non-sequential order, as with a list. Interface elements 520, 525, 530, and 535 may thus be displayed in a pattern and may be selectively positioned by a user of the user device 505. In other examples, interface elements 520, 525, 530, and 535 may be displayed in a card view. In a card view, interface elements 520, 525, 530, and 535 may resemble physical cards. Thus a card view of interface elements 520, 525, 530, and 535 may be displayed two-dimensionally but, when an individual card is selected, a third dimension may be present. For example, by “selecting” a single card (e.g., interface element 520), all of the displayed cards may be reordered, with the selected card appearing first.

In other examples, the display 510 of the user device 505 may include a first length 545, a second length 550, and a third length. The first length 545 may extend in a first direction and the second length 550 may extend in a second direction. The first length 545 and second length 550 may be orthogonal. In some examples, each of the first length 545, the second length 550, the third length 555, or a combination thereof may facilitate the determination of a device type of the user device 505. For example, a certain ratio between the first length 545 and the second length 550 may indicate that the user device 505 is a phone. In another example, the first length 545 and the second length 550 may be a same length, which may indicate that the user device 505 is a laptop. In yet another example, the third length 555, alone, may indicate that the user device 505 is a phone. In any example, any combination of the first length 545, the second length 550, and the third length 555 may facilitate the determination of the device type of the user device 505.

In one example embodiment, the user device 505 may determine first identification information that includes at least one of a device type of the user device 505, a timestamp, or location information of the user device 505. The device type may be a tablet. Subsequently, for example, the user device 505 may transmit a request to access a user profile of a mobile application. The request may include the identification information—that the user device 505 is a tablet. The user device 505 may receive an indication of the user profile that is based in part on the user device 505 transmitting a request to access the user profile. The indication of the user profile may include interface elements 520, 525, 530, and 535—in that specific order—due to the fact that the user device 505 is a tablet. Additionally or alternatively, for example, the interface elements 520, 525, 530, and 535 may be specifically-ordered due to a prior use of the user interface 515 and the tablet. The user interface 515 may be displayed on the tablet, via display 510, based in part on the indication of the user profile.

In another example embodiment, the user device 505 (e.g., the tablet) may receive a second indication of the user profile at the user device based in part on a change in device type. For example, the user may cease using a tablet and begin using his or her phone. The user may again wish to access the mobile application. Due to the change in the user device 505, the second indication of the user profile may include interface elements 525, 535, 520, and 530—in that specific order—due to the change in user device 505. Additionally or alternatively, for example, the interface elements 525, 535, 520, and 530 may be specifically-ordered due to a prior use of the user interface 515 and the phone.

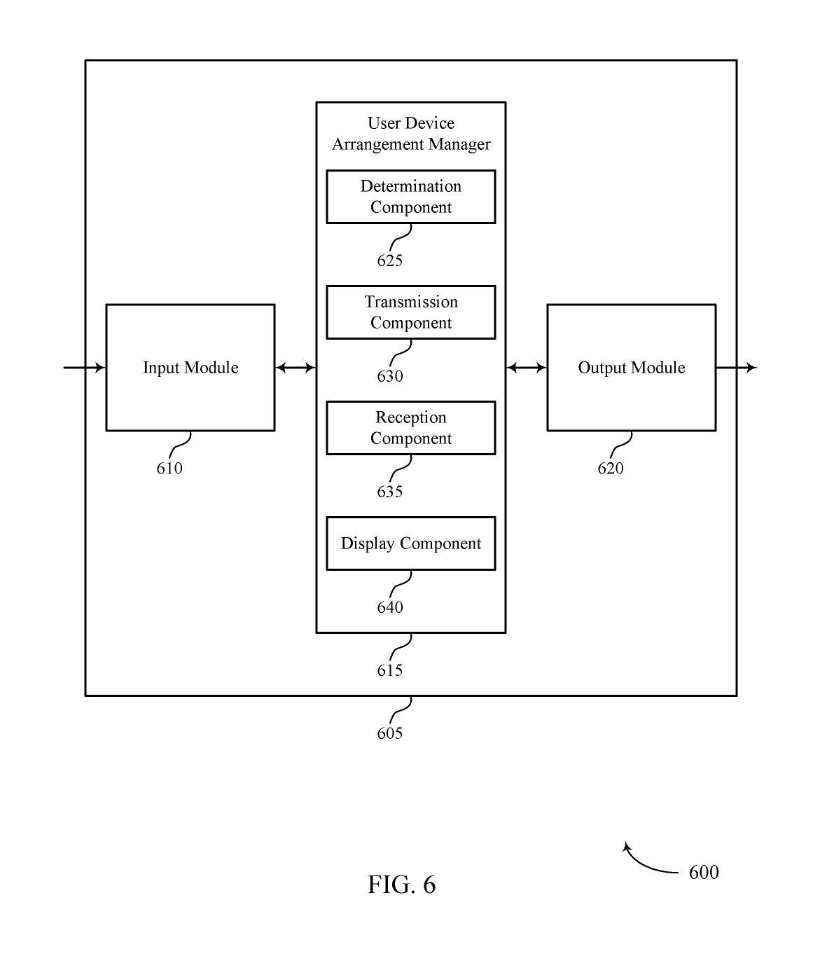

FIG. 6 shows a block diagram 600 of an apparatus 605 that supports user pattern prediction using a neural network in accordance with aspects of the present disclosure. Apparatus 605 may include input module 610, user device arrangement manager 615, and output module 620. Apparatus 605 may also include a processor. Each of these components may be in communication with one another (e.g., via one or more buses). In some cases, apparatus 605 may be an example of a user terminal, a database server, or a system containing multiple computing devices.

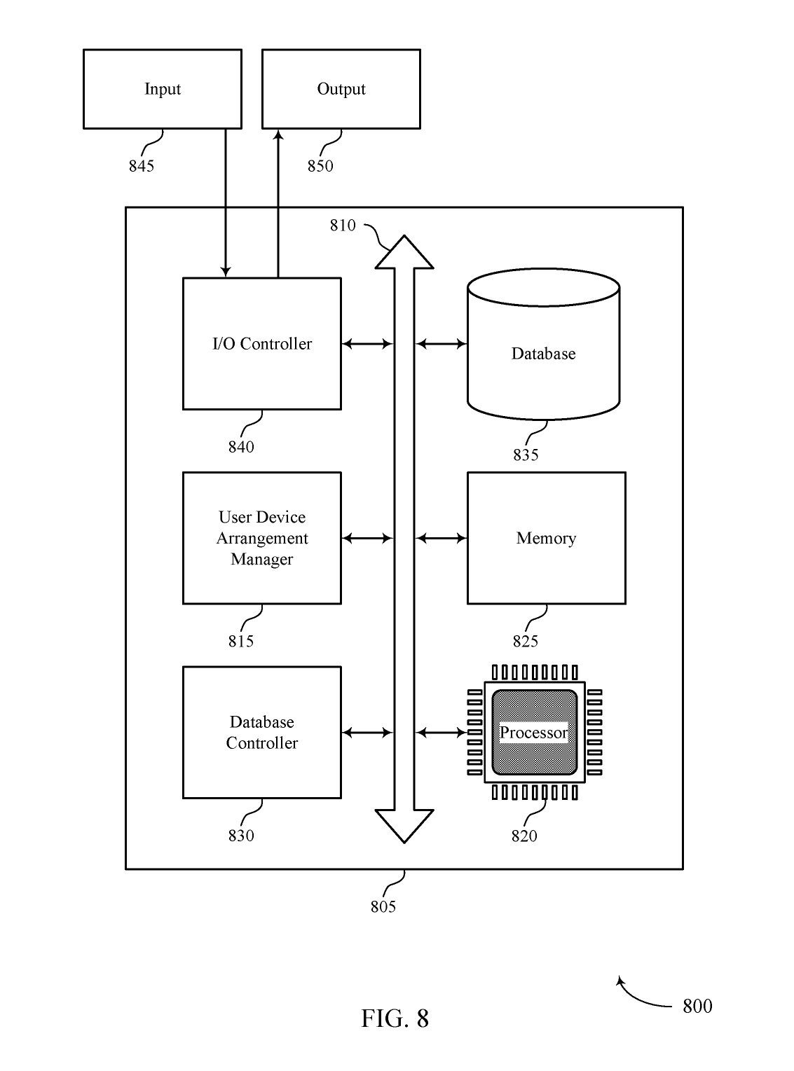

User device arrangement manager 615 may be an example of aspects of the user device arrangement manager 815 described with reference to FIG. 8.

User device arrangement manager 615 and/or at least some of its various sub-components may be implemented in hardware, software executed by a processor, firmware, or any combination thereof. If implemented in software executed by a processor, the functions of the user device arrangement manager 615 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The user device arrangement manager 615 and/or at least some of its various sub-components may be physically located at various positions, including being distributed such that portions of functions are implemented at different physical locations by one or more physical devices. In some examples, user device arrangement manager 615 and/or at least some of its various sub-components may be a separate and distinct component in accordance with various aspects of the present disclosure. In other examples, user device arrangement manager 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

User device arrangement manager 615 may also include determination component 625, transmission component 630, reception component 635, and display component 640.

Determination component 625 may determine first identification information of the user device. In some examples, the first identification information may include a device type of the user device and may determine second identification information of the user device. In other examples, the second identification information may include a timestamp, location information of the user device, or both.

Transmission component 630 may transmit a request to access a user profile for the user device to a server. In some examples, the request may include the first identification information.

Reception component 635 may receive an indication of the user profile at the user device based on transmitting the request. In some examples, the indication of the user profile may include an arrangement of elements on the user interface that are based on a prior use of the user interface. In other examples, the reception component 635 may receive a second indication of the user profile at the user device based on a change in the device type. The second indication of the user profile may be different than the indication of the user profile. In some examples, the reception component 635 may receive a third indication of the user profile at the user device based on a change in second identification information.

Display component 640 may display the user interface at the user device based on the indication of the user profile. In some examples, display component 640 may display the user interface at the user device based on the second indication of the user profile. In other examples, display component 640 may display the user interface at the user device based on the third indication of the user profile. In some cases, the user device may include a display that includes a first length extending in a first direction and a second length extending in a second direction orthogonal to the first direction. In other examples, the device type may be based on the first length, the second length, or both. In some cases, the user interface may be based on a characteristic of the user profile. Additionally or alternatively, for example, the user interface may include at least one list, at least one application icon, a card, or a combination thereof. In other cases, displaying the user interface may include determining an order of the at least one list, the at least one application icon, or the card based on an association between the first identification information and the user profile.

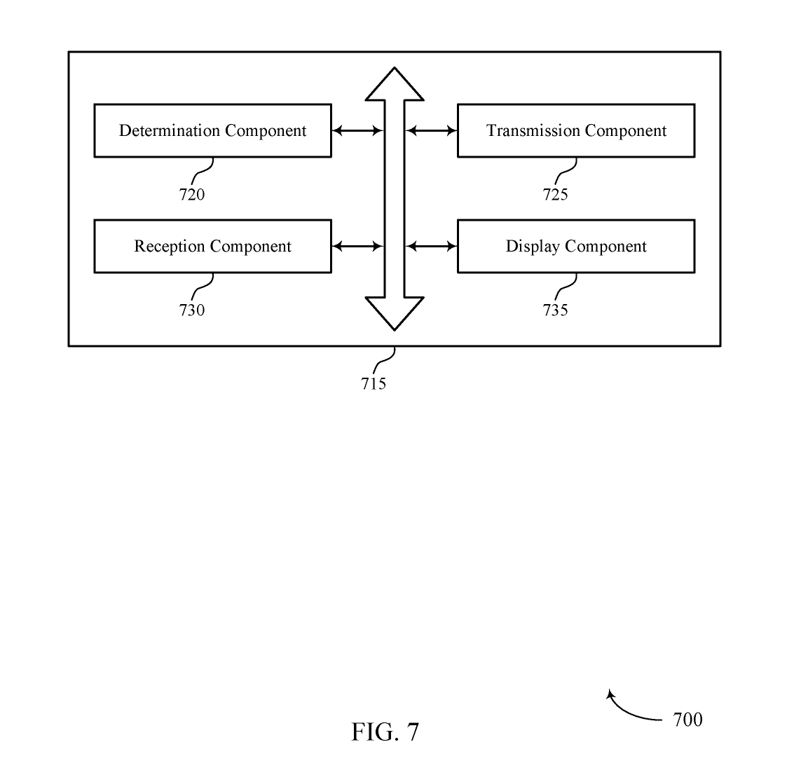

FIG. 7 shows a block diagram 700 of a user device arrangement manager 715 that supports user pattern prediction using a neural network in accordance with aspects of the present disclosure. The user device arrangement manager 715 may be an example of aspects of a user device arrangement manager 815 described with reference to FIGS. 5, 6, and 8. The user device arrangement manager 715 may include determination component 720, transmission component 725, reception component 730, and display component 735. Each of these modules may communicate, directly or indirectly, with one another (e.g., via one or more buses).

Determination component 720 may determine first identification information of the user device. In some examples, the first identification information may include a device type of the user device and determine second identification information of the user device. In other examples, the second identification information may include a timestamp, location information of the user device, or both.

Transmission component 725 may transmit a request to access a user profile for the user device to a server. In some examples, the request may include the first identification information.

Reception component 730 may receive an indication of the user profile at the user device based on transmitting the request. In other examples, the indication of the user profile may include an arrangement of elements on the user interface that are based on a prior use of the user interface. Additionally or alternatively, for example, the reception component 730 may receive a second indication of the user profile at the user device based on a change in the device type. In some examples, the second indication of the user profile may be different than the indication of the user profile. In other examples, the reception component 730 may receive a third indication of the user profile at the user device based on a change in second identification information.

Display component 735 may display the user interface at the user device based on the indication of the user profile. In other examples, the display component 735 may display the user interface at the user device based on the second indication of the user profile. Additionally or alternatively, for example, the display component 735 may display the user interface at the user device based on the third indication of the user profile. In some cases, the user device may include a display that includes a first length extending in a first direction and a second length extending in a second direction orthogonal to the first direction. In other examples, the device type may be based on the first length, the second length, or both. In some cases, the user interface may be based on a characteristic of the user profile. In some cases, the user interface may include at least one list, at least one application icon, at least one card, or a combination thereof. In other examples cases, displaying the user interface may include determining an order of the at least one list, the at least one application icon, or the card based on an association between the first identification information and the user profile.

FIG. 8 shows a diagram of a system 800 including a device 805 that supports user pattern prediction using a neural network in accordance with aspects of the present disclosure. Device 805 may be an example of or include the components of user device 205 as described above, e.g., with reference to FIG. 2. Device 805 may include components for bi-directional data communications including components for transmitting and receiving communications, including user device arrangement manager 815, processor 820, memory 825, database controller 830, database 835, and I/O controller 840. These components may be in electronic communication via one or more buses (e.g., bus 810).

Processor 820 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute computer-readable instructions stored in a memory to perform various functions (e.g., functions or tasks supporting user pattern prediction using a neural network).

Memory 825 may include random access memory (RAM) and read only memory (ROM). The memory 825 may store computer-readable, computer-executable software 830 including instructions that, when executed, cause the processor to perform various functions described herein. In some cases, the memory 825 may contain, among other things, a basic input/output system (BIOS) which may control basic hardware or software operation such as the interaction with peripheral components or devices.

Database controller 830 may manage data storage and processing in database 835. In some cases, a user may interact with database controller 830. In other cases, database controller 830 may operate automatically without user interaction.

Database 835 may be an example of a single database, a distributed database, multiple distributed databases, or an emergency backup database.

I/O controller 840 may manage input and output signals for device 805. I/O controller 840 may also manage peripherals not integrated into device 805. In some cases, I/O controller 840 may represent a physical connection or port to an external peripheral. In some cases, I/O controller 840 may utilize an operating system such as iOS®, ANDROID®, MS-DOS®, MS-WINDOWS®, OS/2®, UNIX®, LINUX®, or another known operating system. In other cases, I/O controller 840 may represent or interact with a modem, a keyboard, a mouse, a touchscreen, or a similar device. In some cases, I/O controller 840 may be implemented as part of a processor. In some cases, a user may interact with device 805 via I/O controller 840 or via hardware components controlled by I/O controller 840.

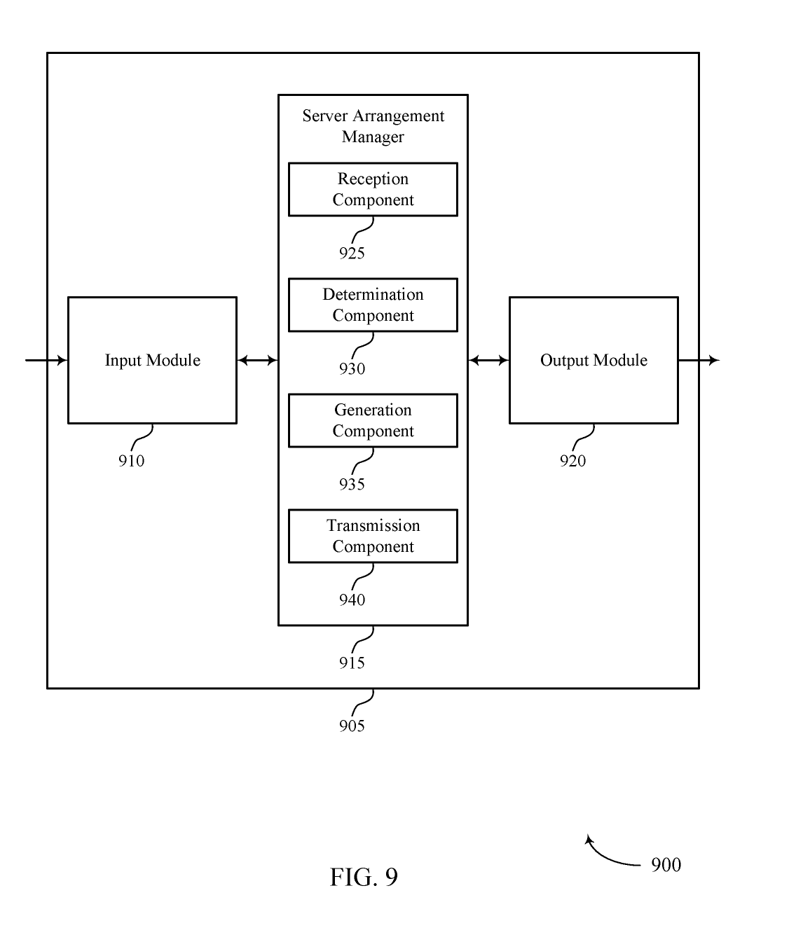

FIG. 9 shows a block diagram 900 of an apparatus 905 that supports user pattern prediction using a neural network in accordance with aspects of the present disclosure. Apparatus 905 may include input module 910, server arrangement manager 915, and output module 920. Apparatus 905 may also include a processor. Each of these components may be in communication with one another (e.g., via one or more buses). In some cases, apparatus 905 may be an example of a user terminal, a database server, or a system containing multiple computing devices.

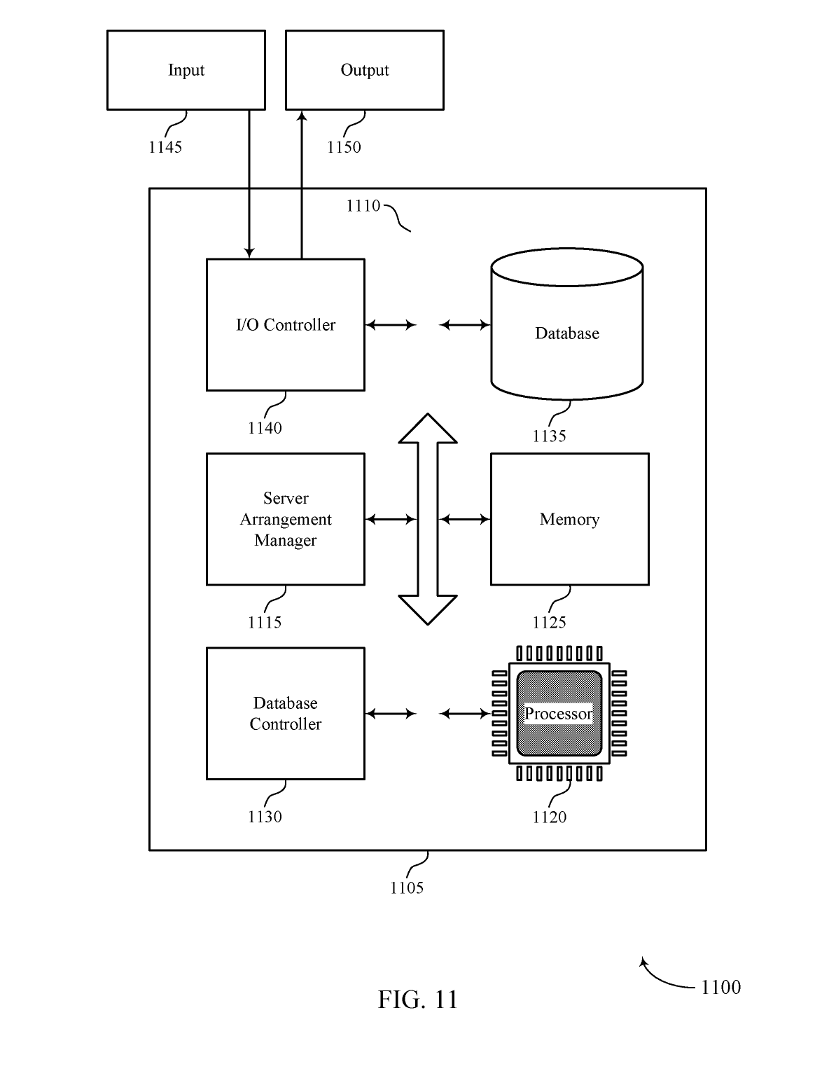

Server arrangement manager 915 may be an example of aspects of the server arrangement manager 1115 described with reference to FIG. 11.

Server arrangement manager 915 and/or at least some of its various sub-components may be implemented in hardware, software executed by a processor, firmware, or any combination thereof. If implemented in software executed by a processor, the functions of the server arrangement manager 915 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The server arrangement manager 915 and/or at least some of its various sub-components may be physically located at various positions, including being distributed such that portions of functions are implemented at different physical locations by one or more physical devices. In some examples, server arrangement manager 915 and/or at least some of its various sub-components may be a separate and distinct component in accordance with various aspects of the present disclosure. In other examples, server arrangement manager 915 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Server arrangement manager 915 may also include reception component 925, determination component 930, generation component 935, and transmission component 940.

Reception component 925 may receive first identification information of a user device at the server. In other examples, reception component 925 may receive a request to access a user profile from the user device, where the request includes the first identification information. In other examples, reception component 925 may receive a second request to access the user profile from the user device. The second request may include additional identification information from the user device. In other examples, the first identification information may include a timestamp, location information of the user device, or both.

Determination component 930 may determine a device type of the user device at the server based on receiving the first identification information of the user device.

Generation component 935 may generate an indication of the user profile at the server based on receiving the request. In some examples, the indication of the user profile may include an arrangement of elements to be displayed on the user interface that are based on a prior use of the user interface. Additionally or alternatively, for example, generation component 935 may generate a second indication of the user profile at the server. In some examples, the second indication of the user profile may include a second arrangement of elements to be displayed on the user interface that is different than the arrangement of elements. In other examples, the generation component 935 may generate a third indication of the user profile at the server that is different than the indication of the user interface based on a change in the additional identification information. In some examples, the generation component 935 may generate a notification at the server based on receiving the request or receiving the second request.

Transmission component 940 may transmit the indication of the user profile to the user device. In some examples, the transmission component 940 may transmit the second indication of the user profile to the user device. Additionally or alternatively, for example, the transmission component 940 may transmit the third indication of the user profile to the user device, and may transmit the notification to the user device.

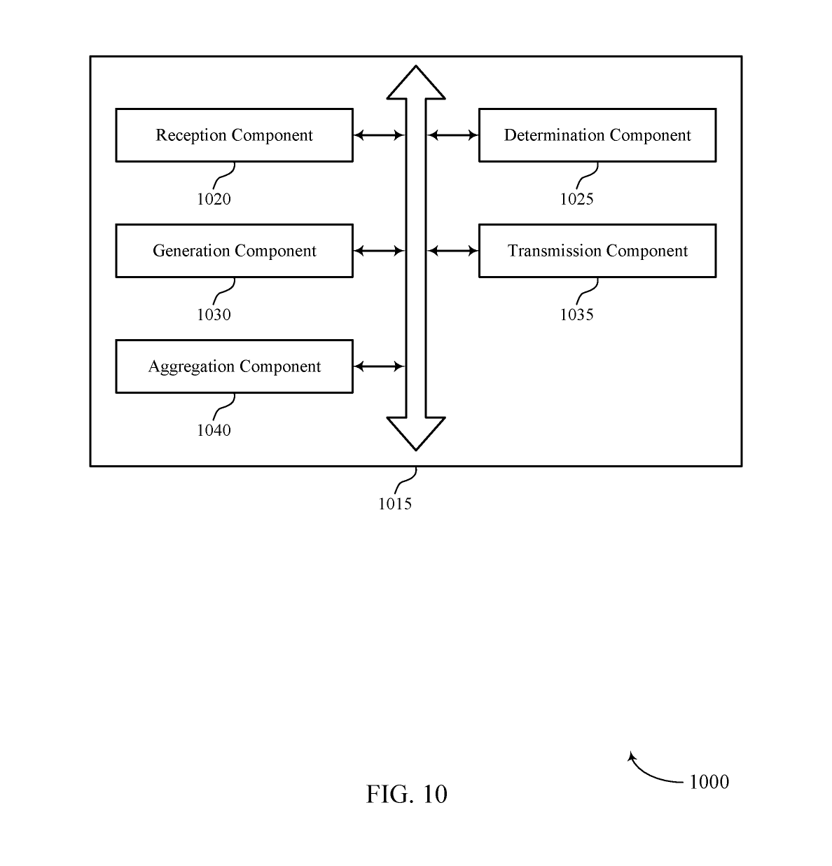

FIG. 10 shows a block diagram 1000 of a server arrangement manager 1015 that supports user pattern prediction using a neural network in accordance with aspects of the present disclosure. The server arrangement manager 1015 may be an example of aspects of a server arrangement manager 1115 described with reference to FIGS. 8, 9, and 11. The server arrangement manager 1015 may include reception component 1020, determination component 1025, generation component 1030, transmission component 1035, and aggregation component 1040. Each of these modules may communicate, directly or indirectly, with one another (e.g., via one or more buses).

Reception component 1020 may receive first identification information of a user device at the server. In some examples, the reception component 1020 may receive a request to access a user profile from the user device. In other examples, the request may include the first identification information. Additionally or alternatively, for example, the reception component 1020 may receive a second request to access the user profile from the user device, where the second request may include additional identification information from the user device. In other examples, the first identification information may include a timestamp, location information of the user device, or both.

Determination component 1025 may determine a device type of the user device at the server based on receiving the first identification information of the user device.

Generation component 1030 may generate an indication of the user profile at the server based on receiving the request. In some examples, the indication of the user profile may include an arrangement of elements to be displayed on the user interface that are based on a prior use of the user interface. In other examples, the generation component 1030 may generate a second indication of the user profile at the server. The second indication of the user profile may include a second arrangement of elements to be displayed on the user interface that is different than the arrangement of elements. Additionally or alternatively, for example, the generation component 1030 may generate a third indication of the user profile at the server that is different than the indication of the user interface based on a change in the additional identification information. In other examples, the generation component 1030 may generate a notification at the server based on receiving the request or receiving the second request.

Transmission component 1035 may transmit the indication of the user profile to the user device. In other examples, the transmission component 1035 may transmit the second indication of the user profile to the user device. In some examples, the transmission component 1035 may transmit the third indication of the user profile to the user device, and may transmit the notification to the user device.

Aggregation component 1040 may aggregate first identification information from a set of user devices at the server. In some examples, generating the indication of the user profile may be based on the aggregating the first identification information.

FIG. 11 shows a diagram of a system 1100 including a device 1105 that supports user pattern prediction using a neural network in accordance with aspects of the present disclosure. Device 1105 may be an example of or include the components of server 210 as described above, e.g., with reference to FIG. 2. Device 1105 may include components for bi-directional data communications including components for transmitting and receiving communications, including server arrangement manager 1115, processor 1120, memory 1125, database controller 1130, database 1135, and I/O controller 1140. These components may be in electronic communication via one or more buses (e.g., bus 1110).

Processor 1120 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting user pattern prediction using a neural network).

Memory 1125 may include RAM and ROM. The memory 1125 may store computer-readable, computer-executable software 1130 including instructions that, when executed, cause the processor to perform various functions described herein. In some cases, the memory 1125 may contain, among other things, a BIOS which may control basic hardware or software operation such as the interaction with peripheral components or devices.

Database controller 1130 may manage data storage and processing in database 1135. In some cases, a user may interact with database controller 1130. In other cases, database controller 1130 may operate automatically without user interaction.

Database 1135 may be an example of a single database, a distributed database, multiple distributed databases, or an emergency backup database.

I/O controller 1140 may manage input and output signals for device 1105. I/O controller 1140 may also manage peripherals not integrated into device 1105. In some cases, I/O controller 1140 may represent a physical connection or port to an external peripheral. In some cases, I/O controller 1140 may utilize an operating system such as iOS®, ANDROID®, MS-DOS®, MS-WINDOWS®, OS/2®, UNIX®, LINUX®, or another known operating system. In other cases, I/O controller 1140 may represent or interact with a modem, a keyboard, a mouse, a touchscreen, or a similar device. In some cases, I/O controller 1140 may be implemented as part of a processor. In some cases, a user may interact with device 1105 via I/O controller 1140 or via hardware components controlled by I/O controller 1140.

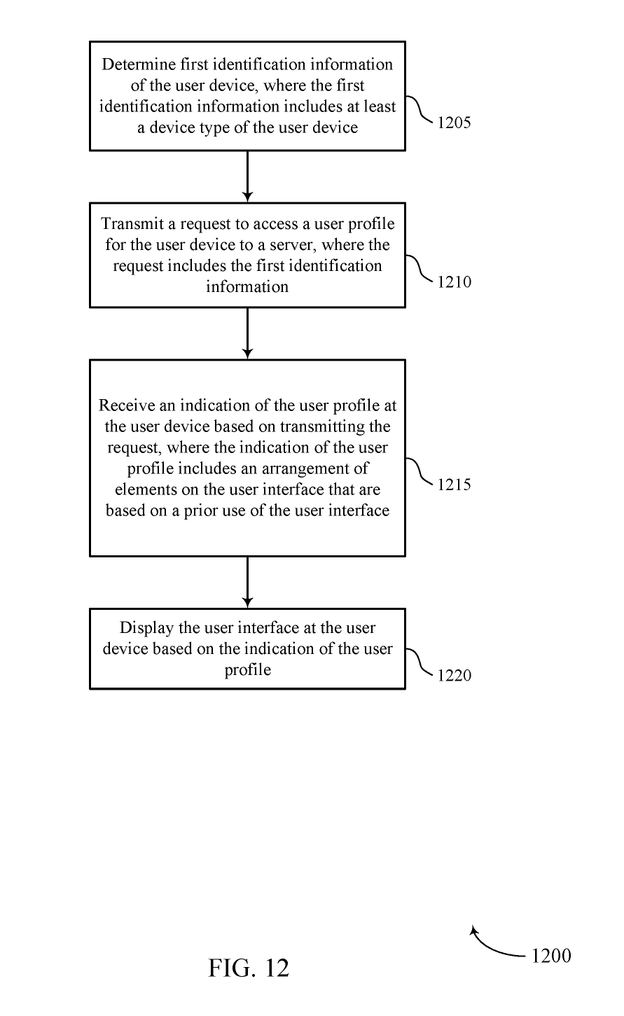

FIG. 12 shows a flowchart illustrating a method 1200 for user pattern prediction using a neural network in accordance with aspects of the present disclosure. The operations of method 1200 may be implemented by a user device or its components as described herein. For example, the operations of method 1200 may be performed by a user device arrangement manager as described with reference to FIGS. 6 through 8. In some examples, a user device may execute a set of codes to control the functional elements of the device to perform the functions described below. Additionally or alternatively, the user device may perform aspects of the functions described below using special-purpose hardware.

At 1205 the user device may determine first identification information of the user device. In some examples, the first identification information may include a device type of the user device, a timestamp, or location information of the user device. The operations of 1205 may be performed according to the methods described herein. In certain examples, aspects of the operations of 1205 may be performed by a determination component as described with reference to FIGS. 6 through 8.

At 1210 the user device may transmit a request to access a user profile for the user device to a server. In some examples, the request may include the first identification information. The operations of 1210 may be performed according to the methods described herein. In certain examples, aspects of the operations of 1210 may be performed by a transmission component as described with reference to FIGS. 6 through 8.

At 1215 the user device may receive an indication of the user profile at the user device based at least in part on transmitting the request. In some examples, the indication of the user profile may include an arrangement of elements on the user interface that are based at least in part on a prior use of the user interface corresponding to the first identification information. The operations of 1215 may be performed according to the methods described herein. In certain examples, aspects of the operations of 1215 may be performed by a reception component as described with reference to FIGS. 6 through 8.

At 1220 the user device may display the user interface at the user device based at least in part on the indication of the user profile. The operations of 1220 may be performed according to the methods described herein. In certain examples, aspects of the operations of 1220 may be performed by a display component as described with reference to FIGS. 6 through 8.

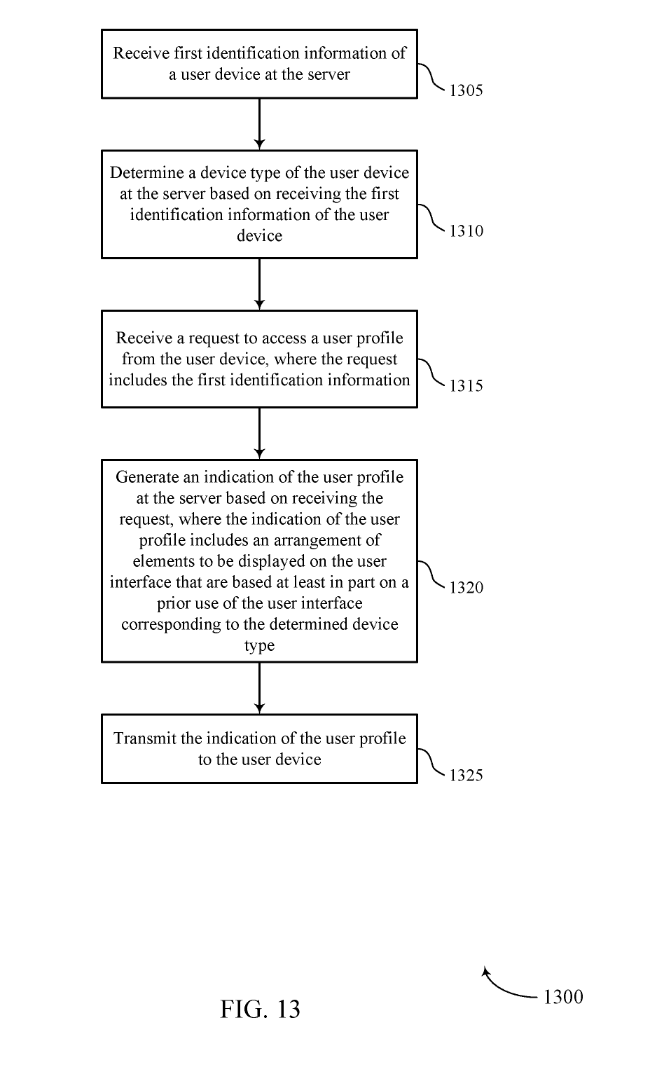

FIG. 13 shows a flowchart illustrating a method 1300 for user pattern prediction using a neural network in accordance with aspects of the present disclosure. The operations of method 1300 may be implemented by a server or its components as described herein. For example, the operations of method 1300 may be performed by a server arrangement manager as described with reference to FIGS. 9 through 11. In some examples, a server may execute a set of codes to control the functional elements of the device to perform the functions described below. Additionally or alternatively, the server may perform aspects of the functions described below using special-purpose hardware.

At 1305 the server may receive first identification information of a user device at the server. The operations of 1305 may be performed according to the methods described herein. In certain examples, aspects of the operations of 1305 may be performed by a reception component as described with reference to FIGS. 9 through 11.

At 1310 the server may determine a device type of the user device at the server based at least in part on receiving the first identification information of the user device. The operations of 1310 may be performed according to the methods described herein. In certain examples, aspects of the operations of 1310 may be performed by a determination component as described with reference to FIGS. 9 through 11.

At 1315 the server may receive a request to access a user profile from the user device. In some examples, the request may include the first identification information. The operations of 1315 may be performed according to the methods described herein. In certain examples, aspects of the operations of 1315 may be performed by a reception component as described with reference to FIGS. 9 through 11.

At 1320 the server may generate an indication of the user profile at the server based at least in part on receiving the request. In some examples, the indication of the user profile may include an arrangement of elements to be displayed on the user interface that are based at least in part on a prior use of the user interface corresponding to the first identification information. The operations of 1320 may be performed according to the methods described herein. In certain examples, aspects of the operations of 1320 may be performed by a generation component as described with reference to FIGS. 9 through 11.

At 1325 the server may transmit the indication of the user profile to the user device. The operations of 1325 may be performed according to the methods described herein. In certain examples, aspects of the operations of 1325 may be performed by a transmission component as described with reference to FIGS. 9 through 11.

A method of arranging a user interface of an application at a user device is described. The method may include determining first identification information of the user device. In some examples, the first identification information may include a device type of the user device, a timestamp, or location information of the user device. In other examples, the method may include transmitting a request to access a user profile for the user device to a server. The request may include the first identification information. Additionally or alternatively, for example, the method may include receiving an indication of the user profile at the user device based at least in part on transmitting the request. In some examples, the indication of the user profile may include an arrangement of elements on the user interface that are based at least in part on a prior use of the user interface corresponding to the first identification information. In other examples, the method may include displaying the user interface at the user device based at least in part on the indication of the user profile.

Another apparatus for arranging a user interface of an application at a user device is described. The apparatus may include a processor, memory in electronic communication with the processor, and instructions stored in the memory. The instructions may be operable to cause the processor to determine first identification information of the user device. In some examples, the first identification information may include a device type of the user device, a timestamp, or location information of the user device. In other examples, the instructions may be operable to cause the processor to transmit a request to access a user profile for the user device to a server. The request may include the first identification information. In some examples, the instructions may be operable to cause the processor to receive an indication of the user profile at the user device based at least in part on transmitting the request. The indication of the user profile may include an arrangement of elements on the user interface that are based at least in part on a prior use of the user interface corresponding to the first identification information. Additionally or alternatively, for example, the instructions may be operable to cause the processor to display the user interface at the user device based at least in part on the indication of the user profile.

Some examples of the method and apparatus described above may further include processes, features, means, or instructions for receiving a second indication of the user profile at the user device based at least in part on a change in the device type, wherein the second indication of the user profile may be different than the indication of the user profile. Additionally or alternatively, for example, some examples of the method and apparatus described above may further include processes, features, means, or instructions for displaying the user interface at the user device based at least in part on the second indication of the user profile.

Some examples of the method and apparatus described above may further include processes, features, means, or instructions for determining second identification information of the user device, wherein the second identification information comprises a timestamp, location information of the user device, or both. Additionally or alternatively, for example, some examples of the method and apparatus described above may further include processes, features, means, or instructions for receiving a third indication of the user profile at the user device based at least in part on a change in second identification information. Other examples of the method and apparatus described above may further include processes, features, means, or instructions for displaying the user interface at the user device based at least in part on the third indication of the user profile.

In some examples of the method and apparatus described above, the user device may include a display that includes a first length extending in a first direction and a second length extending in a second direction orthogonal to the first direction. The device type may be based at least in part on the first length, the second length, or both. In some examples of the method and apparatus described above, the user interface may be based at least in part on a characteristic of the user profile. In other examples of the method and apparatus described above, the user interface may include at least one list, at least one application icon, at least one card, or a combination thereof.

In some examples of the method and apparatus described above, displaying the user interface may include determining an order of the at least one list, the at least one application icon, or the card based at least in part on an association between the first identification information and the user profile.

A method of arranging a user interface of an application at a server is described. The method may include receiving first identification information of a user device at the server. In some examples, the method may include determining a device type of the user device at the server based at least in part on receiving the first identification information of the user device. In other examples, the method may include receiving a request to access a user profile from the user device. The request may include the first identification information. Additionally or alternatively, for example, the method may include generating an indication of the user profile at the server based at least in part on receiving the request. The indication of the user profile may include an arrangement of elements to be displayed on the user interface that are based at least in part on a prior use of the user interface corresponding to the determined device type. In other examples, the method may include transmitting the indication of the user profile to the user device.

Another apparatus for arranging a user interface of an application is described. The apparatus may include a processor, memory in electronic communication with the processor, and instructions stored in the memory. The instructions may be operable to cause the processor to receive first identification information of a user device at the server. In other examples, the instructions may be operable to cause the processor to determine a device type of the user device at the server based at least in part on receiving the first identification information of the user device. Additionally or alternatively, for example, the instructions may be operable to cause the processor to receive a request to access a user profile from the user device. The request may include the first identification information. In other examples, the instructions may be operable to cause the processor to generate an indication of the user profile at the server based at least in part on receiving the request. In some examples, the indication of the user profile may include an arrangement of elements to be displayed on the user interface that are based at least in part on a prior use of the user interface corresponding to the first identification information. In other examples, the instructions may be operable to cause the processor to transmit the indication of the user profile to the user device.

Some examples of the method and apparatus described above may further include processes, features, means, or instructions for generating a second indication of the user profile at the server. In some examples, the second indication of the user profile may include a second arrangement of elements to be displayed on the user interface that may be different than the arrangement of elements. Some examples of the method and apparatus described above may further include processes, features, means, or instructions for transmitting the second indication of the user profile to the user device.

Some examples of the method and apparatus described above may further include processes, features, means, or instructions for receiving a second request to access the user profile from the user device. In some examples, the second request may include additional identification information from the user device, and wherein the first identification information comprises a timestamp, location information of the user device, or both. Other examples of the method and apparatus described above may further include processes, features, means, or instructions for generating a third indication of the user profile at the server that may be different than the indication of the user interface based at least in part on a change in the additional identification information. Some examples of the method and apparatus described above may further include processes, features, means, or instructions for transmitting the third indication of the user profile to the user device.

Other examples of the method and apparatus described above may further include processes, features, means, or instructions for generating a notification at the server based at least in part on receiving the request or receiving the second request. Some examples of the method and apparatus described above may further include processes, features, means, or instructions for transmitting the notification to the user device. Some examples of the method and apparatus described above may further include processes, features, means, or instructions for aggregating first identification information from a plurality of user devices at the server. In some examples, generating the indication of the user profile may be based at least in part on the aggregating the first identification information.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for arranging a user interface of an application at a user device, comprising:
determining first identification information of the user device, wherein the first identification information comprises at least one of a device type of the user device, a timestamp, or location information of the user device;
transmitting a request to access a user profile for the user device to a server, wherein the request comprises the first identification information;
receiving an indication of the user profile at the user device based at least in part on transmitting the request, wherein the indication of the user profile comprises an arrangement of elements on the user interface that is based at least in part on a prior use of the user interface corresponding to the first identification information; and
displaying the user interface at the user device based at least in part on the indication of the user profile.

2. The method of claim 1, further comprising:
receiving a second indication of the user profile at the user device based at least in part on a change in the first identification information, wherein the second indication of the user profile is different than the indication of the user profile; and
displaying the user interface at the user device based at least in part on the second indication of the user profile.

3. The method of claim 1, further comprising:
determining second identification information of the user device, wherein the second identification information is different than the first identification information.

4. The method of claim 3, further comprising:
receiving a third indication of the user profile at the user device based at least in part on a change in second identification information; and
displaying the user interface at the user device based at least in part on the third indication of the user profile.

5. The method of claim 1, wherein the user device comprises a display that includes a first length extending in a first direction and a second length extending in a second direction orthogonal to the first direction, wherein the device type is based at least in part on the first length, the second length, or both.

6. The method of claim 1, wherein the user interface is based at least in part on a characteristic of the user profile.

7. The method of claim 1, wherein the user interface comprises at least one list, at least one application icon, at least one card, or a combination thereof.

8. The method of claim 7, wherein displaying the user interface comprises:
determining an order of the at least one list, the at least one application icon, or both based at least in part on an association between the first identification information and the user profile.

9. A method for arranging a user interface of an application at a server, comprising:
receiving first identification information of a user device at the server;
determining a device type of the user device at the server based at least in part on receiving the first identification information of the user device;
receiving a request to access a user profile from the user device, wherein the request comprises the first identification information;
generating an indication of the user profile at the server based at least in part on receiving the request, wherein the indication of the user profile comprises an arrangement of elements to be displayed on the user interface that are based at least in part on a prior use of the user interface corresponding to the determined device type; and
transmitting the indication of the user profile to the user device.

10. The method of claim 9, further comprising:
generating a second indication of the user profile at the server, wherein the second indication of the user profile comprises a second arrangement of elements to be displayed on the user interface that is different than the arrangement of elements; and
transmitting the second indication of the user profile to the user device.

11. The method of claim 9, further comprising:
receiving a second request to access the user profile from the user device, wherein the second request comprises additional identification information from the user device, and wherein the first identification information comprises a timestamp, location information of the user device, or both.

12. The method of claim 11, further comprising:
generating a third indication of the user profile at the server that is different than the indication of the user interface based at least in part on a change in the additional identification information; and
transmitting the third indication of the user profile to the user device.

13. The method of claim 11, further comprising:
generating a notification at the server based at least in part on receiving the request or receiving the second request; and
transmitting the notification to the user device.

14. The method of claim 9, further comprising:
aggregating first identification information from a plurality of user devices at the server, wherein generating the indication of the user profile is based at least in part on the aggregating the first identification information.

15. An apparatus for arranging a user interface of an application at a user device, comprising:
a processor;
memory in electronic communication with the processor; and
instructions stored in the memory and executable by the processor to cause the apparatus to:
determine first identification information of the user device, wherein the first identification information comprises a device type of the user device;
transmit a request to access a user profile for the user device to a server, wherein the request comprises the first identification information;
receive an indication of the user profile at the user device based at least in part on transmitting the request, wherein the indication of the user profile comprises an arrangement of elements on the user interface that are based at least in part on a prior use of the user interface; and
display the user interface at the user device based at least in part on the indication of the user profile.

16. The apparatus of claim 15, wherein the instructions are further executable by the processor to cause the apparatus to:
receive a second indication of the user profile at the user device based at least in part on a change in the device type, wherein the second indication of the user profile is different than the indication of the user profile; and
display the user interface at the user device based at least in part on the second indication of the user profile.

17. The apparatus of claim 15, wherein the instructions are further executable by the processor to cause the apparatus to:
determine second identification information of the user device, wherein the second identification information comprises a timestamp, location information of the user device, or both.

18. The apparatus of claim 17, wherein the instructions are further executable by the processor to cause the apparatus to:
receive a third indication of the user profile at the user device based at least in part on a change in second identification information; and
display the user interface at the user device based at least in part on the third indication of the user profile.

19. The apparatus of claim 15, wherein the user device comprises a display that includes a first length extending in a first direction and a second length extending in a second direction orthogonal to the first direction, wherein the device type is based at least in part on the first length, the second length, or both

20. The apparatus of claim 15, wherein the user interface comprises at least one list, at least one application icon, at least one card, or a combination thereof.
